(19) United States
(12) Patent Application Publication
(10) Pub. No.: US 2022/0363576 A1
(43) Pub. Date: Nov. 17, 2022

(54) SILICA REDUCER COMPOSITIONS AND METHODS FOR TREATMENT OF PRODUCED WATER FROM THERMAL IN SITU BITUMEN OR HEAVY HYDROCARBON RECOVERY OPERATIONS

(71) Applicant: BAYMAG INC., Calgary (CA)

(72) Inventors: Neil BEREZOWSKI, Calgary (CA); Maryam JAFARI, Calgary (CA); Gang SHI, Calgary (CA); Franz Xaver SPACHTHOLZ, Calgary (CA); Richard SPROUL, Calgary (CA)

(21) Appl. No.: 17/706,857

(22) Filed: Mar. 29, 2022

(30) Foreign Application Priority Data
May 11, 2021 (CA) 3117808

(51) Int. Cl. C02F 5/06; C01F 5/06

(52) U.S. Cl. CPC C02F 5/06; C01F 5/06; C02F 2103/10

(57) ABSTRACT

The present disclosure relates to the treatment of produced water from SAGD operations or other thermal in situ hydrocarbon recovery operations. The innovative products and techniques have been developed by Baymag Inc, a subsidiary of Refratechnik Holding GmbH. For example, the disclosure relates to a silica reducer composition for use in warm or hot lime softeners or evaporators for treating produced water generated from in situ hydrocarbon recovery operations. The silica reducer composition has an enhanced combination of particle sizing and surface area for facilitating silica reduction while minimizing hydration. The silica reducer composition can be manufactured by calcining followed by milling and other optional process steps.

### TECHNICAL FIELD

The technical field generally relates to the treatment of produced water from thermal in situ bitumen or heavy hydrocarbon recovery operations, and more particularly to the removal of silica from produced water streams using magnesium oxide based compositions in equipment such as lime softeners and evaporators as well as manufacturing methods for such silica reducer compositions.

### BACKGROUND

Produced water is generated in the context of in situ heavy hydrocarbon recovery operations and can be treated at a surface facility to remove contaminants. In steam assisted processes, such as steam-assisted gravity drainage (SAGD) and cyclic steam stimulation (CSS), steam is injected into the reservoir to heat and mobilize heavy hydrocarbons and then production fluid that includes hydrocarbons and water is recovered to surface. The production fluid is separated into water and hydrocarbon streams, and the water is often referred to as produced water. The water is further treated to remove contaminants, such as silica, in order to be suitable for reuse as boiler feed water to produce steam for reinjection into the reservoir.

One conventional produced water treatment stage is lime softening, which can be done in a warm lime softener or a hot lime softener. The produced water can also be supplied into an evaporator to produce contaminant-reduced condensate. Other treatment units can also be used to remove additional contaminants and generate boiler feed water that is suitable to be fed into a steam generation unit, which can be a once-through steam generator (OTSG). Chemical additives, such as magnesium oxide, can be mixed with the produced water to aid removal of contaminants.

There are various challenges in terms of the efficient treatment of produced water for in situ heavy hydrocarbon recovery operations.

### SUMMARY

Techniques described herein relate to compositions, methods of manufacture and processes for the reduction of silica in produced water from thermal in situ heavy hydrocarbon recovery operations.

In some implementations, there is provided a silica reducer composition for use in a produced water treatment vessel, comprising magnesium oxide in a concentration between 90 wt % and 99 wt % on a loss free basis, wherein the magnesium oxide is in the form of particles having a specific surface area between 20 m²/g and 65 m²/g and a median particle sizing of between 3 and 20 microns.

The silica reducer composition can have a calcium oxide concentration below 4.0 wt % or 2.5 wt % on a loss free basis, a ferric oxide concentration below 3.0 wt % or 1.5 wt % on a loss free basis, an aluminum oxide concentration below 1.5 wt % or 1.0 wt % on a loss free basis, and/or a silicon oxide concentration below 1.5 wt % or 1.0 wt % on a loss free basis. The concentration of the magnesium oxide can be at least 95 wt %, 96 wt %, 97 wt %, or between 95.5 wt % and 98 wt %, on a loss free basis. The median particle sizing can be below 15, 10 or 5 microns. The specific surface area of the particles of the magnesium oxide can be between 20 m²/g and 40 m²/g, between 20 m²/g and 35 m²/g, between 25 m²/g and 35 m²/g, or between 28 m²/g and 32 m²/g. A preferred range can be between 25 m²/g and 35 m²/g for many applications. The composition can have a loose bulk density of 0.30 to 0.75 kg/L, a packed bulk density of 0.80 to 1.2 kg/L, and loss on ignition of between 1 and 3.5 wt %.

In some implementations, the specific surface area of the particles of the magnesium oxide is provided to inhibit hydration of the magnesium oxide above 10% for a residence time between addition into the produced water until entering the produced water treatment vessel at an operating temperature. The operating temperature can be between 20° C. and 50° C. and the residence time can be between 1 and 45 minutes.

In some implementations, there is provided a method of manufacturing a silica reducer composition, comprising: calcining a magnesium containing material to form a calcined material comprising calcined magnesium oxide; and milling the calcined material to form the silica reducer composition having a magnesium oxide concentration between 90 wt % and 99 wt % on a loss free basis, a specific surface area between 20 m²/g and 65 m²/g, and a median particle sizing of between 3 and 20 microns.

The calcining can be performed in a calciner furnace unit, which can include a multiple hearth furnace (MHF), a rotary kiln, a shaft furnace, a fluidized bed furnace or a gas suspension calciner, or a combination thereof. The calciner furnace unit can include at least a first stage furnace and a second stage furnace, or a single furnace vessel. The magnesium containing material can include magnesite and/or magnesium hydroxide and/or limestone and/or dolomite rock and/or brucite and/or magnesium carbonate and/or hydrated magnesium carbonate, or any combination thereof. The magnesium containing material can include or consist of ore or a material derived from ore. The ore can be subjected to crushing to produce a crushed ore that is subjected to the calcining. The magnesium containing material can also be synthetic and derived from a magnesium containing brine.

In some implementations, the method includes subjecting the calcined material to beneficiation to increase a magnesium oxide content thereof prior to the milling. The beneficiation can include physical beneficiation, chemical beneficiation, or a combination thereof.

In some implementations, all of the calcined material from the calcining step is supplied to the milling step, but it is also possible that only a portion of the calcined material from the calcining step is supplied to the milling step.

In some implementations, the calcining is performed at a firing temperature of 600° C. to 1100° C., preferably 800° C. to 1050° C.

In some implementations, the milling is performed in a ball mill, an impact mill, or a combination thereof.

In some implementations, a target surface area of the silica reducer composition is obtained by performing the calcining such that the calcined magnesium oxide has a first predetermined surface area, and performing the milling such that the silica reducer composition undergoes a predetermined surface area increase to obtain the target surface area.

In some implementations, there is provided a use of magnesium oxide particles as a silica reducer composition in a produced water treatment vessel, the magnesium oxide particles having a specific surface area between 20 m²/g and 65 m²/g and a median particle size less than 20 microns. Preferably the specific surface area between 25 m²/g and 35 m²/g.

In some implementations, the produced water treatment vessel is a lime softener, such as a warm lime softener or a hot lime softener. In some implementations, the produced water treatment vessel is an evaporator.

In some implementations, the silica reducer composition is added to the produced water in the form of a slurry or in dry form. In some implementations, the silica reducer composition is added directly into the produced water treatment vessel or into a feed line that supplies the produced water to the produced water treatment vessel.

In some implementations, there is provided a process for treating produced water generated in a thermal in situ bitumen or heavy hydrocarbon recovery operation, the process comprising: adding a silica reducer composition to the produced water; feeding the produced water into a produced water treatment vessel comprising a warm lime softener, a hot lime softener, an evaporator, or a combination thereof, wherein the silica reducer composition comprises magnesium oxide in a concentration between 90 wt % and 99 wt % on a loss free basis and in the form of particles having a specific surface area between 20 m²/g and 65 m²/g and a median particle sizing of between 3 and 20 microns; and withdrawing a treated water stream from the produced water treatment vessel.

In some implementations, the silica reducer composition is added in the form of a slurry, and the slurry optionally comprises less than 10 wt % or between 4 wt % and 8 wt % of the silica reducer composition.

In some implementations, the silica reducer composition is added to the produced water to provide a residence time between addition and the entering the produced water treatment vessel such that the magnesium oxide undergoes hydration below 10% or below 5%, at a produced water temperature. In some implementations, the produced water temperature is between 20° C. and 50° C. and/or the residence time is between 1 and 45 minutes. In some implementations, the silica reducer composition is added to the produced water at a dosage to reduce a silica content from an initial silica concentration above about 200 ppm to a treated concentrate below 50 ppm or 30 ppm.

### BRIEF DESCRIPTION OF THE DRAWINGS

FIG. 1 is flow diagram of a method of manufacturing a silica reducer composition.

FIG. 2 is a flow diagram of a process for treating produced water where a lime softener is implemented.

FIG. 3 is a flow diagram of a process for treating produced water where an evaporator is implemented.

FIG. 4 is a graph of hydration percentage versus slaking time at different temperatures.

FIG. 5 is a graph of silica content versus dosage of magnesium oxide for two products added to produced water and each having different particle sizes.

### DETAILED DESCRIPTION

The present disclosure relates to silica reducer compositions for use in lime softeners or evaporators that treat produced water generated from thermal in situ bitumen or heavy hydrocarbon recovery operations. The disclosure particularly relates to the application of compositions that include magnesium oxide (MgO) for silica reduction from produced water in Warm Lime Softener (WLS), Hot Lime Softener (HLS), or evaporators for in situ heavy oil operations, such that those typically used in Alberta, Canada.

In some implementations, the silica reducer composition is a free-flowing magnesium oxide based product that can be produced by calcining high purity natural magnesite developed specifically for this application. Without being limited by theory, silica reduction from produced water can be facilitated by the adsorption and/or co-precipitation with MgO and/or magnesium hydroxide (Mg(OH)₂). MgO hydration, which is also known as slaking, occurs when MgO and water are mixed to form Mg(OH)₂ slurry via the following reactions:

Dissociation: MgO+H₂O↔Mg²⁺+2OH⁻

Precipitation: Mg²⁺+2OH⁻↔H Mg(OH)₂

Silica removal efficiency is notably decreased if the MgO in the slurry hydrates to Mg(OH)₂ before entering the produced water treatment vessel (e.g., WLS, HLS or evaporator). As illustrated in FIG. 4, the magnesium oxide feed system can be advantageously designed with low retention times and low water temperature. The silica reducer composition can include magnesium oxide having a relatively reduced particle size for enhanced silica reduction while maintaining a specific surface area that promotes resistance to the premature formation of magnesium hydroxide.

In a typical steam-assisted in situ heavy hydrocarbon recovery operation, much of the steam injected into the reservoir is recovered as produced water at the surface. The produced water must be treated and recycled for further steam production. The water treatment can include WLS or HLS precipitation softening processes for hardness and silica removal, followed by filtration for suspended solids removal, and a weak acid cation (WAC) exchange to remove remaining dissolved hardness. The resulting treated water can be suitable for use as boiler feed water and is fed to a steam generator, such as a drum boiler or an OTSG.

Warm or hot lime softening is a process which combines lime and magnesium oxide slurries with warm or hot produced water to remove silica and hardness. In some implementations, hydrated lime is added to the produced water and reacts with the bicarbonates in the water to form CaCO₃. Magnesium oxide can be added as a slurry into the rapid mix zone of WLS or HLS units where it reacts with water to form Mg(OH)₂. The conversion of MgO to Mg(OH)₂ preferably occurs within the water treatment vessel (e.g., WLS, HLS, or evaporator) to ensure maximum surface interaction for silica adsorption and subsequent removal. The resulting CaCO₃ and Mg(OH)₂ solids are removed from the water treatment vessel as part of the sludge.

In some implementations, the silica reducer composition has reduced particle size characteristics to leverage size effects for silica removal via adsorption mechanisms. The smaller particle size provides an increase in adsorption sites for reaction per unit volume of the composition. The silica reducer composition can have a particle sizing where a minimum of 96.5 wt % of the particles pass through a 200-mesh screen. The particle sizing can also be provided such that the silica reducer composition has a median particle size less than 20 microns. In addition, the specific surface area of the silica reducer composition can be provided between 20 m²/g and 65 m²/g or between 25 m²/g and 35 m²/g or between 28 m²/g and 32 m²/g, for example.

In some implementations, the silica reducer composition has one or more additional compositional and physical properties. For example, the reducer composition can have a loose bulk density of 0.30 to 0.75 kg/L, and a packed bulk density of 0.80 to 1.2 kg/L. While the composition is magnesium oxide based with for example between 90 wt % and 99 wt % MgO on a loss free basis, the composition can also include other components, such as various oxides depending on the source of the magnesite ore. For instance, the silica reducer composition can include CaO up to 4% or up to 2.5%, Fe₂O₃ up to 3% or up to 1.5%, Al₂O₃ up to 1.5% or up to 1%, and SiO₂ up to 1.5% or up to 1%, all being on a loss free basis. The silica reducer composition can also have a loss on ignition of between about 1 and 3.5 wt %.

The silica reducer composition can be formulated and manufactured in various ways to provide a product having target compositional, particle size and specific surface area properties. By providing the specific surface area below 65 m²/g, below 55 m²/g, below 45 m²/g, below 35 m²/g, or preferably between 25 m²/g and 35 m²/g, the composition can have reduced hydration in produced water treatment applications, such that the magnesium oxide does not substantially convert to magnesium hydroxide before it reaches the produced water treatment vessel. For a given material, lower surface areas facilitate lower hydration rates of the magnesium oxide. For instance, a preferred surface area in the range of 25 m²/g and 35 m²/g can facilitate reduced hydration rates for enhanced application of the silica reducer to produced water streams.

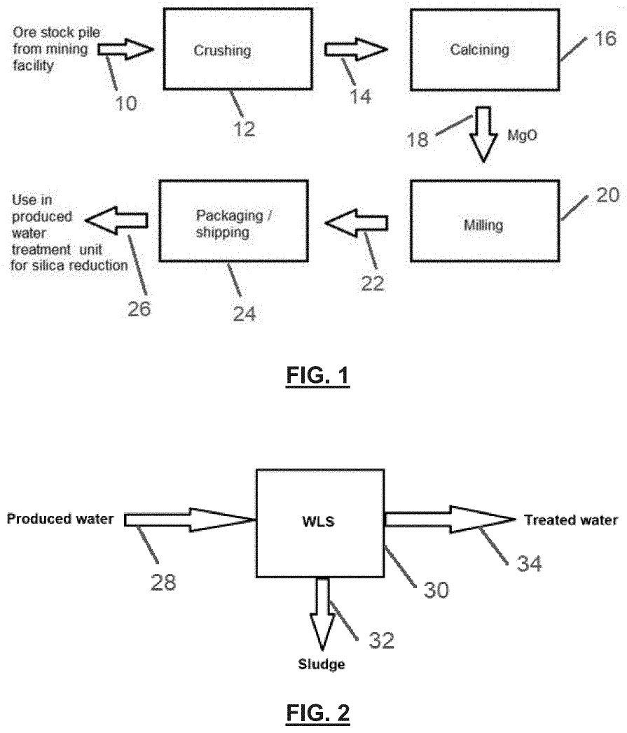

The silica reducer composition can be manufactured using various processes and starting materials. In one implementation, as shown in FIG. 1, magnesium containing ore 10 is obtained by mining and then supplied to a crushing stage 12 to produce crushed ore 14. The crushed ore 14 is then supplied to a calcining stage 16 that is operated as residence times and temperatures to produce a calcined material 18 having certain desired properties, such as surface area, and comprising magnesium oxide. The calcined material 18 is then supplied to a milling stage 20 to reduce the particle size of the material to produce the silica reducer composition 22. The milling stage increases the surface area only slightly while notably reducing the particle size. The silica reducer composition 22 can have a magnesium oxide concentration between 90 wt % and 99 wt % on a loss free basis, a specific surface area between 20 m²/g and 65 m²/g, and a median particle sizing of between 3 and 20 microns. The silica reducer composition 22 can then subjected to packaging and shipping 24 and the packaged product 26 can be used for addition to produced water that is treated in a water treatment unit for silica reduction.

Turning now to FIG. 2, in the produce water treatment facility, the produced water 28 is supplied to a water treatment unit, such as a WLS 30, for silica removal and removal of other compounds in the produced water. The WLS 30 produces sludge 32 and treated water 34. A similar setup could be implemented with an HLS instead of a WLS.

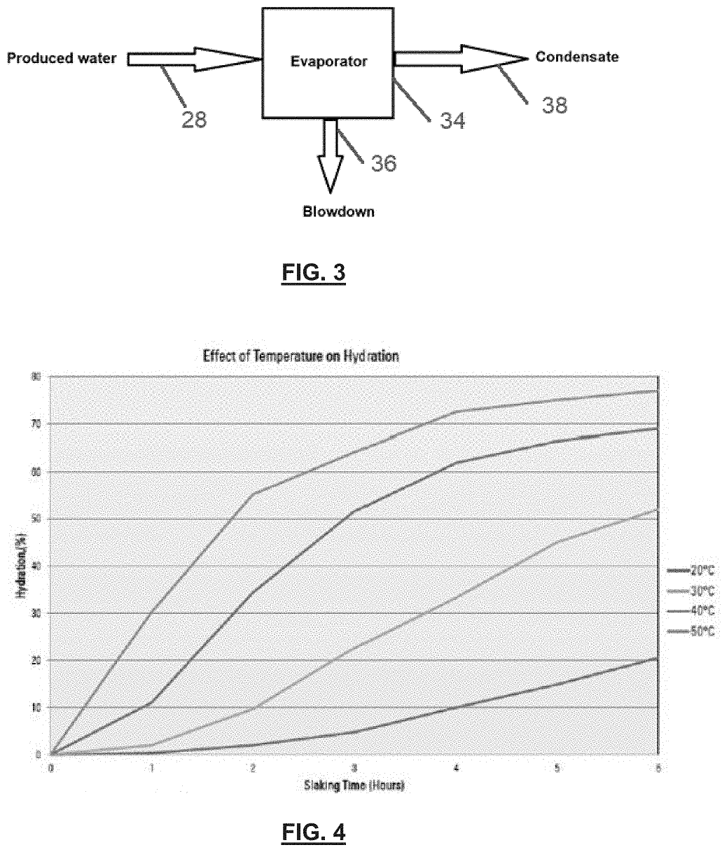

FIG. 3 shows an alternative water treatment unit, i.e., an evaporator 34, which receives the produced water and produces blowdown 36 and condensate 38. The condensate 38 can be considered a treated water stream. The treated water from the WLS or evaporator can also be further treated prior to being used as boiler feed water in an OTSG or another type of steam generator to produce steam for injection into the subterranean reservoir as part of the thermal in situ bitumen or heavy hydrocarbon recovery operation.

### EXPERIMENTATION & DATA

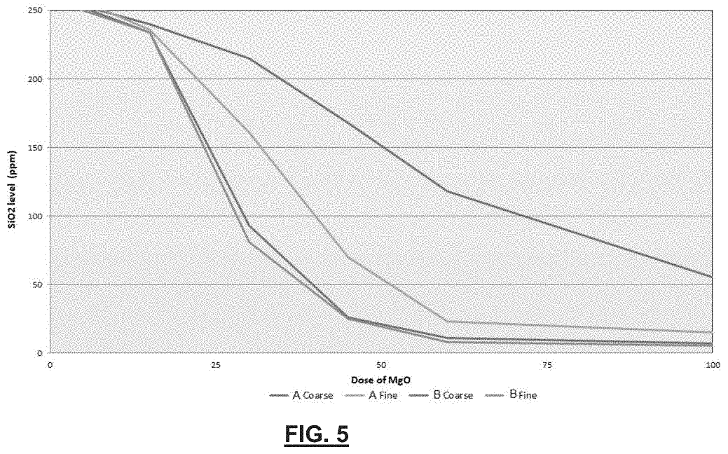

It has been found experimentally that magnesium oxide particle sizing has an impact on silica reduction from produced water. Experiments were conducted to assess two products A and B, each at two different particle sizes “fine” and “coarse”, to assess effects of particle size on silica reduction. For each experimental run, a sample of the produced water was mixed with a dose of the magnesium oxide based product and then allowed to settle. The mixture was then filtered for Inductively Coupled Plasma Mass Spectrometry (ICP-MS) analysis. Results are illustrated in FIG. 5, showing that the “fine” samples of both magnesium oxide based products A and B enabled greater silica reduction compared to the respective “coarse” products. More particularly, for each product A and B, the fine product gave better maximum silica reduction as well as better silica reduction per magnesium oxide dosage compared to the coarse product. The “fine” product A was 98.9% at 200 mesh (median particle sizing below 20 microns) in terms of particle size with a surface area between 25 m²/g and 35 m²/g, while the “fine” product B was 96.6% 325 mesh (median particle sizing below 20 microns) in terms of particle size with a surface area between 45 m²/g and 60 m²/g. The coarse products had a median particle sizing above 20 microns in both cases. It is noteworthy that for the lower surface area product, i.e., product A, the impact of reducing particle size is quite pronounced. The fine product A can facilitate the multiple effects of enhancing silica reduction along with reduced hydration rates and incorporation into existing facilities based on existing operating conditions.

Referring to FIG. 4, the effect of residence time and temperature on hydration is shown. These results illustrate that higher residence times of the magnesium oxide in the produce water and higher temperatures result in great hydration of the magnesium oxide. To reduce hydration, the magnesium oxide based product can be added at a certain location in the process to minimize temperature and the time to reach the water treatment unit. In some scenarios where the product is added into a relatively hot produced water and/or upstream of the treatment unit such that notable slaking time exists prior to the treatment unit, the product can be dosed higher to account for the hydration that occurs before the product reaches the treatment unit. It is also possible to add certain products directly to the treatment unit to minimize slaking.

It is also noted that the particle size reduction to below a median of 20, 15, 10, or 5 microns can be performed while keeping the surface area within a low enough range such that the finer particles do not experience a notable increase in hydration. Since hydration is strongly linked to surface area and not particle size, the particle size can be advantageously reduced to enhance silica reduction while keeping the surface area within an acceptably low range to mitigate against hydration issues.

1. A silica reducer composition for use in a produced water treatment vessel, comprising magnesium oxide in a concentration between 90 wt % and 99 wt % on a loss free basis, wherein the magnesium oxide is in the form of particles having a specific surface area between 20 m²/g and 65 m²/g and a median particle sizing of between 3 and 20 microns.

2. The silica reducer composition of claim 1, further comprising calcium oxide in a concentration below 4.0 wt % on a loss free basis.

3. The silica reducer composition of claim 1, further comprising calcium oxide in a concentration below 2.5 wt % on a loss free basis.

4. The silica reducer composition of claim 1, further comprising ferric oxide in a concentration below 3.0 wt % on a loss free basis.

5. The silica reducer composition of claim 1, further comprising aluminum oxide in a concentration below 1.5 wt % on a loss free basis.

6. The silica reducer composition of claim 1, further comprising aluminum oxide in a concentration below 1.0 wt % on a loss free basis.

7. The silica reducer composition of claim 1, further comprising silicon oxide in a concentration below 1.5 wt % on a loss free basis.

8. The silica reducer composition of claim 1, further comprising silicon oxide in a concentration below 1.0 wt % on a loss free basis.

9. The silica reducer composition of claim 1, wherein the concentration of the magnesium oxide is at least 95 wt % on a loss free basis.

10. The silica reducer composition of claim 1, wherein the concentration of the magnesium oxide is between 95.5 wt % and 98 wt % on a loss free basis.

11. The silica reducer composition of claim 1, wherein the median particle sizing is below 15 microns.

12. The silica reducer composition of claim 1, wherein the median particle sizing is below 10 microns.

13. The silica reducer composition of claim 1, wherein the median particle sizing is below 5 microns.

14. The silica reducer composition of claim 1, wherein the specific surface area of the particles of the magnesium oxide is between 20 m²/g and 40 m²/g.

15. The silica reducer composition of claim 1, wherein the specific surface area of the particles of the magnesium oxide is between 28 m²/g and 32 m²/g.

16. The silica reducer composition of claim 1, wherein the specific surface area of the particles of the magnesium oxide is provided to inhibit hydration of the magnesium oxide above 10% for a residence time between addition into the produced water until entering the produced water treatment vessel at an operating temperature.

17. The silica reducer composition of claim 16, wherein the operating temperature is between 20° C. and 50° C. and the residence time is between 1 and 45 minutes.

18. The silica reducer composition of claim 1, wherein the composition has a loose bulk density of 0.30 to 0.75 kg/L and a packed bulk density of 0.80 to 1.2 kg/L.

19. A method of manufacturing a silica reducer composition, comprising:
calcining a magnesium containing material to form a calcined material comprising calcined magnesium oxide; and
milling the calcined material to form the silica reducer composition having a magnesium oxide concentration between 90 wt % and 99 wt % on a loss free basis, a specific surface area between 20 m²/g and 65 m²/g, and a median particle sizing of between 3 and 20 microns.

20. A process for treating produced water generated in a thermal in situ bitumen or heavy hydrocarbon recovery operation, the process comprising:
adding a silica reducer composition to the produced water;
feeding the produced water into a produced water treatment vessel comprising a warm lime softener, a hot lime softener, an evaporator, or a combination thereof, wherein the silica reducer composition comprises magnesium oxide in a concentration between 90 wt % and 99 wt % on a loss free basis and in the form of particles having a specific surface area between 20 m²/g and 65 m²/g and a median particle sizing of between 3 and 20 microns; and
withdrawing a treated water stream from the produced water treatment vessel.
